(19) United States
(12) Patent Application Publication
(10) Pub. No.: US 2023/0415805 A1
(43) Pub. Date: Dec. 28, 2023

(54) CHILD CARRIER

(71) Applicant: Wonderland Switzerland AG, Steinhaussen (CH)

(72) Inventor: Tao YANG, Dongguan (CN)

(73) Assignee: Wonderland Switzerland AG, Steinhaussen (CH)

(21) Appl. No.: 18/339,321

(22) Filed: Jun. 22, 2023

(30) Foreign Application Priority Data
Jun. 24, 2022 (CN) 202210729542.7

(51) Int. Cl. B62B 7/00; B62B 7/06

(52) U.S. Cl. CPC B62B 7/006; B62B 7/06

(57) ABSTRACT

The present disclosure discloses a child carrier, including a seat plate and a seat plate bracket supporting the seat plate. The seat plate is slidable in frontward and rearward directions relative to the seat plate bracket. The child carrier further includes a locking device configured to locking a position of the seat plate on the seat plate bracket.

### CROSS REFERENCE TO RELATED APPLICATION

This application claims priority to Chinese patent application No. 202210729542.7, filed on Jun. 24, 2022, the entire content of which is incorporated herein by reference in its entirety.

### TECHNICAL FIELD

The present disclosure relates to a child carrier.

### BACKGROUND

Strollers provide great convenience for parents to travel with infants and children, and generally include a frame, a seat plate mounted on the frame, a front armrest, a sunshade assembly, etc. The frame generally includes front support legs, rear support legs, a seat plate bracket, a backrest bracket, a rear armrest, etc. The seat plate is used for children to ride on, and the backrest bracket is used for supporting a backrest configured for the child to lean back on. The front armrest is arranged horizontally above the seat plate and adjacent to a front side, for the child to lean forward. The sunshade assembly can achieve sunshade effect. In order to facilitate the transportation of the strollers, many strollers have a folded state and an unfolded state. The stroller in the unfolded state can be ridden by the child.

When the stroller is in the unfolded state, the relative position between the front armrest and the seat plate is fixed. If the front-rear position relationship between the front armrest and the seat plate is adapted to a child of a small size, a child of a large size may feel crowded when seated. In contrast, if the front-rear position relationship between the front armrest and the seat plate is adapted to the child of the large size, the child of the small size may easily slip out of a gap between the front armrest and the seat plate when seated, and thus there is a potential safety hazard.

### SUMMARY

According to various embodiments of the present disclosure, a child carrier is provided.

A child carrier provided by the present disclosure includes a seat plate and a seat plate bracket supporting the seat plate. The seat plate is slidable in frontward and rearward directions relative to the seat plate bracket. The child carrier further includes a locking device configured to locking a position of the seat plate on the seat plate bracket.

In an embodiment, the seat plate bracket includes at least two positioning holes arranged at intervals in a front-rear direction. The locking device includes a locking member. The locking member includes a locking pin portion. The locking member has a locked position and an unlocked position. When the locking member is in the locked position, the locking pin portion is inserted into corresponding one of the at least two positioning holes to lock a position of the seat plate on the seat plate bracket. When the locking member in the unlocked position, the locking pin portion is withdrawn from the corresponding one of the at least two positioning holes to allow the seat plate to slide along the seat plate bracket.

In an embodiment, the locking device further includes an elastic element. The elastic element is configured to keep the locking member in the locked position. The locking member is capable of switching from the locked position to the unlocked position by overcoming elastic force of the elastic element when subjected to an external force.

In an embodiment, a first guiding mechanism is arranged between the locking member and the seat plate. The first guiding mechanism is configured to guide the locking member to move leftward or rightward, such that the locking member is switched between the locked position and the unlocked position.

In an embodiment, the first guiding mechanism includes a sliding groove or a sliding rail. The sliding groove or the sliding rail extends in a left-right direction. The locking member is slidingly fitted with the sliding groove or the sliding rail. And/or, the first guiding mechanism includes a first elongated hole extending in the left-right direction, and a first connecting post slidingly fitted with the first elongated hole. The first elongated hole is arranged on one of the seat plate and the locking member, the first connecting post is arranged on the other of the seat plate and the locking member.

In an embodiment, a cover plate is mounted on the back of the seat plate. The cover plate covers at least a part of the sliding groove. The cover plate is provided with a second elongated hole extending in the left-right direction. The locking member is provided with a second connecting post. The second connecting post extends through and out of the second elongated hole to receive the external force. The elastic element is mounted in the sliding groove.

In an embodiment, the locking device further includes a first releasing member movable in the frontward and rearward directions. A first conversion mechanism is arranged between the first releasing member and the locking member. The first conversion mechanism is configured to convert frontward and rearward movements of the first releasing member into leftward and rightward movements of the lock member.

In an embodiment, the first conversion mechanism includes an obliquely elongated hole and a fixed post slidingly fitted with the obliquely elongated hole. One of the obliquely elongated hole and the fixed post is arranged on the locking member, and the other of the obliquely elongated hole and the fixed post is arranged on the first releasing member.

In an embodiment, a second guiding mechanism is arranged between the first releasing member and the seat plate. The second guiding mechanism is configured to guide the first releasing member to move in the frontward and rearward directions.

In an embodiment, the seat plate bracket includes two supporting tubes spaced apart in a left-right direction. The at least two positioning holes are arranged on each of the two supporting tubes. The seat plate includes two sliding sleeves sleeved on the two supporting tubes respectively. Two locking members are provided. The two locking members are positioned between the two supporting tubes and face each other in a straight line. The elastic element is clamped between ends of the two locking members which are close to each other; and each of ends of the two locking members away from each other is provided with the locking pin portion.

In an embodiment, the locking members is connected to the seat plate through a pivot shaft. The locking member is rotated around the pivot shaft to be switched between the locked position and the unlocked position.

In an embodiment, the locking device further includes a second releasing member movable in the frontward and rearward directions. A second conversion mechanism is arranged between the second releasing member and the locking member. The second conversion mechanism is configured to convert frontward and rearward movements of the second releasing member into a rotation of the locking member.

In an embodiment, the second conversion mechanism includes a third elongated hole and a third connecting post slidingly fitted with the third elongated hole. One of the third elongated hole and the third connecting post is arranged on the locking member, and the other of the third elongated hole and the third connecting post is arranged on the second releasing member.

In an embodiment, a third guiding mechanism is arranged between the seat plate and the second releasing member. The third guiding mechanism is configured to guide the second releasing member to move in the frontward and rearward directions.

In an embodiment, the elastic element abuts against the second releasing member, and the elastic element acts on the locking member via the second releasing member. Or, the elastic element is a torsion spring sleeved on the pivot shaft, and two spring arms of the torsion spring are respectively connected to the locking member and the seat plate.

In an embodiment, the seat plate bracket includes two supporting tubes spaced apart in a left-right direction, and the at least two positioning holes are arranged on each of the two supporting tubes. The seat plate includes two sliding sleeves sleeved on the two supporting tubes respectively. Two pivot shafts are provided, and the two pivot shafts are spaced apart in the left-right direction. Two locking members are provided, and the two locking members are positioned between the two supporting tubes and sleeved on the two pivot shafts. Ends of the two locking members which are close to each other is connected to the second releasing member; and each of ends of the two locking members away from each other is provided with the locking pin portion.

In an embodiment, the seat plate bracket includes a mounting frame. The locking device includes a nut fixed on a bottom surface of the seat plate, and a lead screw mounted on the mounting frame and extending in a front-rear direction. Axial movement of the lead screw is restricted. A first end of the lead screw is an operating end, and a second end of the lead screw extends through the nut.

In an embodiment, the seat plate bracket includes a supporting tube extending in a front-rear direction. The seat plate includes a sliding sleeve sleeved on the supporting tube. A wall of the sliding sleeve is provided with a threaded hole. The locking device includes a bolt capable of being screwed into the threaded hole. By screwing the bolt, the bolt is engaged with the supporting tube, to lock a position of the sliding sleeve on the supporting tube.

In an embodiment, the child carrier is a stroller or a child dining chair, and a main frame of the child carrier includes a front armrest and the seat plate bracket.

### BRIEF DESCRIPTION OF THE DRAWINGS

FIG. 1 is a perspective view schematically showing a child carrier according to an embodiment of the present disclosure.

FIG. 2 is a side view schematically showing a child carrier according to an embodiment of the present disclosure, with a seat plate positioned in a first position.

FIG. 3 is a side view schematically showing a child carrier according to an embodiment of the present disclosure, with a seat plate positioned in a second position.

FIG. 4 is a bottom perspective view schematically showing a child carrier according to a first embodiment of the present disclosure, with a locking member in a locked position.

FIG. 5 is an exploded view schematically showing a seat plate, a seat plate bracket, and a locking device of the child carrier according to the first embodiment of the present disclosure.

FIG. 6 schematically shows a part of the child carrier shown in FIG. 4, and for ease of illustration, a cover plate in FIG. 4 is not shown.

FIG. 7 is a bottom perspective view schematically showing a child carrier according to a second embodiment of the present disclosure, with a locking member in a locked position.

FIG. 8 schematically shows a part of the child carrier shown in FIG. 7, and for ease of illustration, a first releasing member is not shown in FIG. 8.

FIG. 9 is a perspective view schematically showing the first releasing member of the child carrier according to the second embodiment of the present disclosure.

FIG. 10 schematically shows a partial cross-section of the child carrier according to the second embodiment of the present disclosure, with the locking member is in the locked position.

FIG. 11 schematically shows a partial cross-section of the child carrier according to the second embodiment of the present disclosure, with the locking member in an unlocked position.

FIG. 12 schematically shows a part of the child carrier according to a third embodiment of the present disclosure, from bottom perspective, with a locking member in a locked position.

FIG. 13 schematically shows another part of the child carrier according to the third embodiment of the present disclosure, from bottom perspective, with the locking member in an unlocked position.

FIG. 14 is an exploded view schematically showing a seat plate and a seat plate bracket in the child carrier according to the third embodiment of the present disclosure.

FIG. 15 is a bottom perspective view schematically showing a seat plate and a seat plate bracket of a child carrier according to a fourth embodiment of the present disclosure.

FIG. 16 is another bottom perspective view schematically showing the seat plate and the seat plate bracket of the child carrier according to the fourth embodiment of the present disclosure.

FIG. 17 schematically shows a partial cross-section of the seat plate and the seat plate bracket shown in FIG. 16.

FIG. 18 is a perspective view schematically showing a child carrier according to a fifth embodiment of the present disclosure.

### DETAILED DESCRIPTION OF THE EMBODIMENTS

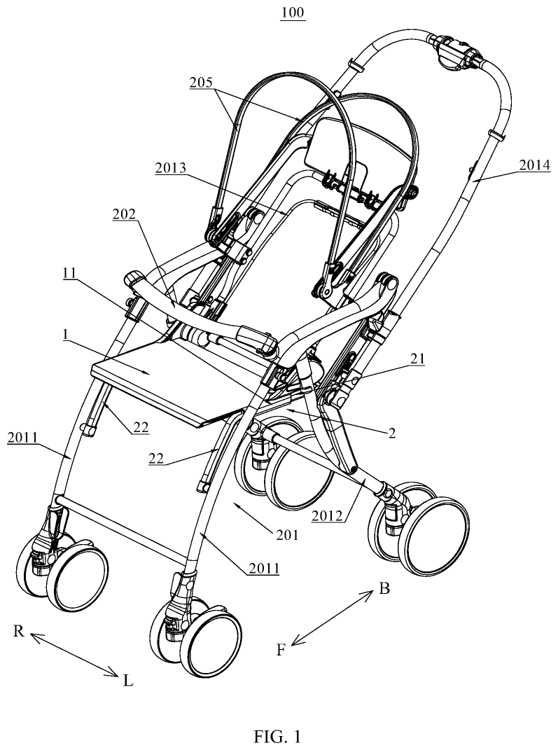

Referring to FIGS. 1 to 3, a child carrier 100 according to an embodiment of the present disclosure is shown. The child carrier 100 in the embodiment of the present disclosure is described by taking a stroller as an example. It can be understood that the type of the child carrier 100 is not limited to the stroller, and can be, for example, a child dining chair or other carrier products for children to ride on.

As shown in FIG. 1, the child carrier 100 may include a main frame 201, and a seat plate 1, and a sunshade assembly 205 mounted on the main frame 201. It is understood that the main frame 201 may have different forms depending on the type of child carrier 100. For example, when the child carrier 100 is a stroller, the main frame 201 may be a movable frame with rollers at the bottom, and when the child carrier 100 is a child dining chair, the main frame 201 may be a high chair frame. The main frame 201 may include front support legs 2011, rear support legs 2012, a front armrest 202, a backrest bracket 2013, a rear armrest 2014, and a seat plate bracket 2. The seat plate 1 is supported by a seat plate bracket 2. The seat plate 1 can slide in frontward and rearward directions relative to the seat plate bracket 2, that is, the seat plate 1 is arranged on the seat plate bracket 2 in such a way that the seat plate 1 can slide in the frontward and rearward directions. By adjusting a position of the seat plate 1 in the front-rear direction, a front-rear position relationship between the seat plate 1 and the front armrest 202 can be adjusted. The child carrier 100 further includes a locking device 3 (as shown in FIG. 4). The locking device 3 is used to lock a position of the seat plate 1 on the seat plate bracket 2, to lock the seat plate 1 in position before or after adjustment.

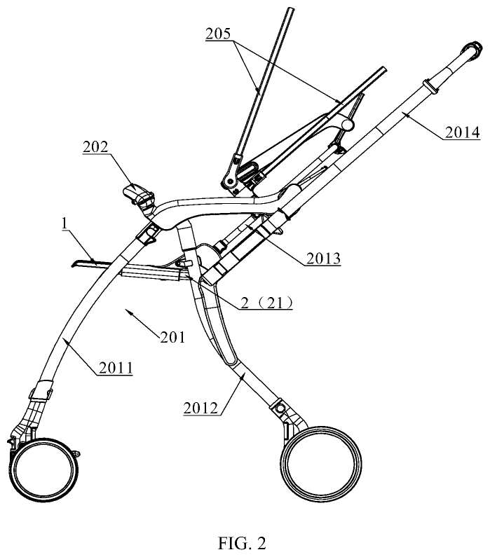

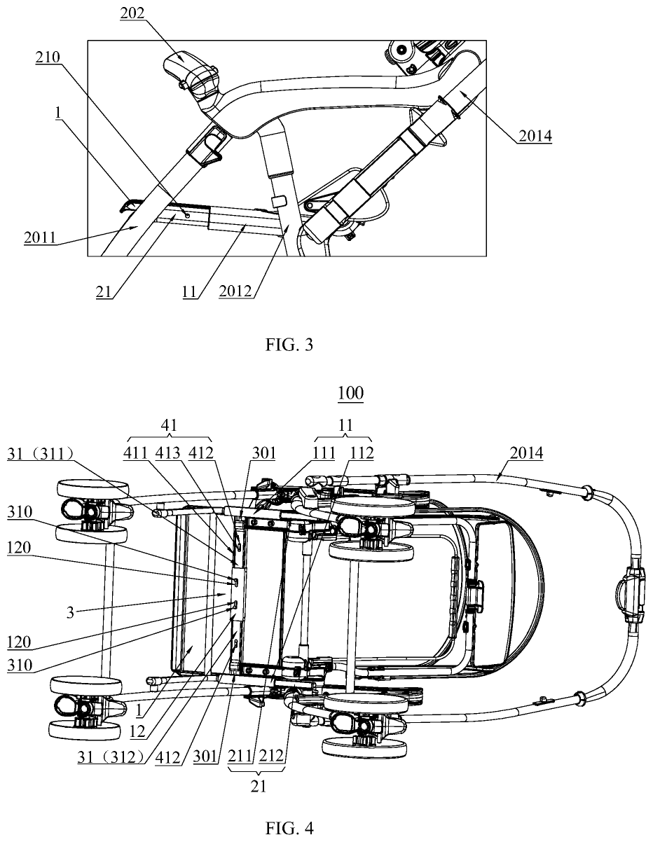

In the child carrier 100 according to the embodiment of the present disclosure, since the front-rear position relationship between the seat plate 1 and the front armrest 202 can be adjusted, the front-rear position relationship between the seat plate 1 and the front armrest 202 can be adapted to seating requirements of children of different sizes. For example, referring to FIG. 2, the seat plate 1 is moved to a first position adjacent to a front side relative to the seat plate bracket 2, which can better meet the seating requirements of children of small sizes. In contrast, referring to FIG. 3, the seat plate 1 can be moved to a second position adjacent to a rear side relative to the seat plate bracket 2, which can provide a larger seating space and better meet the seating requirements of large sizes.

It should be noted that, unless otherwise specified and defined, orientation terms such as “front”, “rear”, “left”, and “right” in embodiments of the present disclosure are based on the orientations of the child carrier 100 in a normal use state (unlocked state), and in figures, arrows F and B are used to schematically show the “front” and “rear” directions, and the arrows L and R are used to schematically show the “left” and “right” directions. These orientation terms are only used to make the description of the embodiments of the present disclosure clearer, and do not constitute an improper limitation on the protection scope of the present disclosure. The child carrier 100 and the locking device 3 thereof will be described in detail below with reference to the drawings and specific embodiments.

FIGS. 4 to 6 show the child carrier 100 according to a first embodiment of the present disclosure.

Referring to FIGS. 1, 4, and 5, the seat plate bracket 2 includes a supporting tube 21 extending in the front-rear direction. A plurality of (two or more) positioning holes 210 are arranged on the supporting tube 21. The positioning holes 210 are arranged at intervals in the front-rear direction of the supporting tube 21, providing multiple adjusting levels for the seat plate 1. The seat plate 1 includes sliding sleeves 11. The sliding sleeves 11 are sleeved on the supporting tubes 21 respectively and can move in the frontward and rearward directions along the supporting tube 21.

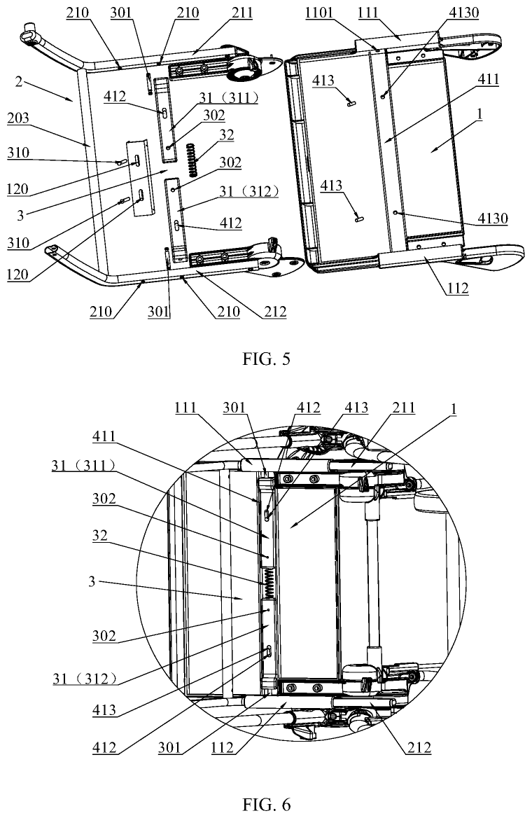

Referring to FIGS. 4 and 5, in the first embodiment, the sliding sleeves 11 are arranged on left and right sides of the seat plate 1. For ease of illustration, the sliding sleeve 11 on the left side is referred to as a first sliding sleeve part 111, and the sliding sleeve 11 on the right side is referred to as a second sliding sleeve part 112. Each of the sliding sleeves 11 (the first sliding sleeve part 111 and the second sliding sleeve part 112) extends in the front-rear direction.

Referring to FIGS. 4 and 5, two supporting tubes 21 are provided correspondingly. The two supporting tubes 21 are spaced apart in a left-right direction. The plurality of positioning holes 210 may be provided on each of the two supporting tubes 21. For ease of illustration, the supporting tube 21 on the left side is referred to as a first tube body 211, and the supporting tube 21 on the right side is referred to as a second tube body 212 herein. The first tube body 211 is sleeved in the first sliding sleeve part 111 to be in a sliding fit with the first sliding sleeve part 111. The second tube body 212 is sleeved in the second sliding sleeve part 112 to be in a sliding fit with the second sliding sleeve part 112.

Referring to FIG. 5, the seat plate bracket 2 may further include one or more connecting cross rods 203 connected between the first tube body 211 and the second tube body 212. When a plurality of connecting cross rods 203 are disposed, without affecting the sliding of the seat plate 1, part of the connecting cross rods 203 can support the seat plate 1 together with the supporting tubes 21 under the seat plate 1. Referring to FIG. 1, in some embodiments, a front end of each of the supporting tubes 21 may be provided with a connecting tube 22. The connecting tube 22 are bent downward relative to the corresponding supporting tube 21 so as to be directly or indirectly connected to the corresponding front support leg 2011 of the main frame 201 (see FIG. 1). In some embodiments, the connecting tube 22 and the corresponding support tube 21 may be formed into one piece. In addition, each of the supporting tubes 21 may be directly or indirectly connected to the corresponding rear support leg 2012 of the main frame 201.

Referring to FIGS. 4 to 6, the locking device 3 is mounted on a bottom surface of the seat plate 1, and includes a locking member 31 and an elastic element 32. In the first embodiment, two locking members 31 are also provided. The two locking members 31 are positioned between the two supporting tubes 21. A first guiding mechanism 41 is arranged between each of the locking members 31 and the seat plate 1. The first guiding mechanism 41 is used to guide the locking member 31 to move in the leftward and rightward directions. For ease of illustration, the locking member 31 on the left side is referred to as a first component 311, and the locking member 31 on the right side is referred to as a second component 312 herein. The first component 311 and the second component 312 face each other in a straight line. Each of ends of the first component 311 and the second component 312 away from each other is provided with the locking pin portion 301. A main body and the locking pin portion 301 of each of the locking members 31 may be integrally formed, or may be connected by welding, screwing, overmolding or the like. The elastic element 32 is clamped between ends of the first component 311 and the second component 312 which are close to each other.

Referring to FIGS. 5 and 6, each of the locking members 31 has a locked position and an unlocked position. Each of the locking members 31 is switched between the locked position and the unlocked position by moving in the leftward and rightward directions. In the locked position, the locking pin portion 301 of each of the locking members 31 is inserted into the corresponding positioning hole 210 of the supporting tube 21 to lock a position of each of the sliding sleeves 11 on the corresponding supporting tube 21, that is, to lock a position of the seat plate 1 on the seat plate bracket 2. In this case, the seat plate 1 is not allowed to move in the frontward and rearward directions relative to the seat plate bracket 2. In the unlocked position, the locking pin portion 301 of each of the locking members 31 is withdrawn from the corresponding positioning hole 210 of the supporting tube 21 to allow each of the sliding sleeves 11 to slide along the corresponding supporting tube 21, allowing the seat plate 1 to move freely along the seat plate bracket 2 in the frontward and rearward directions, thereby adjusting the front-rear position relationship between the front armrest 202 and the seat plate 1. Referring to FIG. 6, it can be understood that driven by the elastic force exerted by the elastic element 32, each of the locking members 31 can be automatically kept in the locked position. When an external force opposite to the elastic force of the elastic element 32 is directly or indirectly applied to each of the locking members 31, and when each of the locking members 31 is driven by the external force, the locking pin portion 301 of each of the locking members 31 is withdrawn from the corresponding positioning hole 210, and the locking member 31 is correspondingly switched from the locked position to the unlocked position.

Referring to FIG. 5, in the first embodiment, each of the sliding sleeves 11 is on a motion trajectory of the locking pin portion 301 of the corresponding locking member 31, so that each of the sliding sleeves 11 is provided with a through hole 1101 through which the locking pin portion 301 of each of the locking members 31 passes. In some embodiments, the motion trajectory of the locking pin portion 301 of each of the lock members 31 may not intersect with the corresponding sliding sleeve 11, that is, each of the locking pin portions 301 may be directly inserted into the corresponding positioning hole 210 without passing through the corresponding sliding sleeve 11.

It should be noted that, in other embodiments, the structures of the seat plate 1, the seat plate bracket 2, and the locking device 3 are not limited herein. For example, in some unillustrated embodiments, sliding grooves, which slidably cooperate with the supporting tubes 21 respectively, are arranged on the bottom of the seat plate 1, and each of the locking members 31 can pass through a wall of the sliding groove to be engaged into the corresponding positioning hole 210 of the supporting tube 21. In addition, in some unillustrated embodiments, in the case of arranging two supporting tubes 21, only one supporting tube 21 may be provided with a plurality of positioning holes 210, and the other supporting tube 21 may not be provided with the positioning hole 210. Accordingly, only one locking member 31 can be arranged. One end of the elastic element 32 is pressed against the one locking member 31, and the other end of the elastic element 32 may be restricted by any structure fixed on the bottom surface of the seat plate 1. In addition, in some unillustrated embodiments, the number of sliding sleeves 11 and supporting tubes 21 may not be limited to two. For example, the seat plate bracket 2 may only include one supporting tube 21 positioned below a middle part of the seat plate 1, and a plurality of positioning holes 210 may be arranged on the one supporting tube 21. Accordingly, one sliding sleeve 11 is also arranged on the seat plate 1. The one sliding sleeve 11 is positioned in the middle of the bottom surface of the seat plate 1 and is sleeved on the supporting tube 21. Accordingly, one locking member 31 may be arranged. When the locking pin portion 301 of the locking member 31 is inserted into any one of the positioning holes 210, the position of the seat plate 1 is locked, on the contrary, when the locking pin portion 301 of the locking member 31 is withdrawn from the positioning hole 210, the seat plate 1 can slide frontward and rearward.

Referring to FIGS. 4 to 6, an exemplary configuration of the first guiding mechanism 41 is illustrated in the first embodiment. The first guiding mechanism 41 may include a sliding groove 411 extending in the left-right direction. The locking member 31 is slidingly fitted with the sliding groove 411 respectively, and the elastic element 32 is also mounted in the sliding groove 411. Certainly, in other embodiments, the sliding groove 411 can alternatively be a sliding rail, and the locking member 31 is slidingly fitted with the sliding rail respectively. In addition, the first guiding mechanism 41 may further include pairs of a first elongated hole 412 and a first connecting post 413. The first elongated hole 412 extends in the left-right direction, the first connecting post 413 is slidingly fitted with the first elongated hole 412. The first elongated hole 412 in each of the pairs of the first elongated hole 412 and the first connecting post 413 is arranged on a corresponding locking member 31, and the first connecting post 413 extends through the first elongated hole 412 and is connected to a fixed hole 4130 of the seat plate 1. Certainly, in other embodiments, the positions of the first elongated hole 412 and the positions of the first connecting post 413 can be interchanged.

Continuing to refer to FIGS. 4 to 6, an exemplary configuration of each of the locking members 31 used for receiving external force is illustrated in the first embodiment. A cover plate 12 is mounted on the back of the seat plate 1. The cover plate 12 is fixed to a wall of the sliding groove 411 or the bottom surface of the seat plate 1, for example, by screws. The cover plate 12 covers at least a part of the sliding groove 411. For example, the cover plate 12 completely covers the elastic element 32 and covers a part of each of the locking member 31. The cover plate 12 is provided with two second elongated holes 120 spaced apart in the left-right direction. Each of the second elongated holes 120 extends in the left-right direction. A second connecting post 310 is arranged on each of the locking members 31. Each second connecting post 310 is connected to a hole 302 on the corresponding locking member 31, for example, after extending through the corresponding second elongated hole 120. When it is necessary to switch each of the locking members 31 to the unlocked position to adjust the position of the seat plate 1, an external force can be applied to the two second connecting posts 310, so that the second connecting posts 310 approach each other in the left-right direction, that is, the locking pin portion 301 of each of the locking members 31 can be easily withdrawn from the corresponding positioning hole 210. After the seat plate 1 is adjusted in place, the external force is removed, the elastic element 32 may push each of the locking members 31 to be away from each other in the left-right direction, and the locking pin portion 301 of each of the locking members 31 may be inserted in the corresponding positioning hole 210, that is, the seat plate 1 is locked in the adjusted position.

It can be understood that, in other embodiments, when the locking device 3 is provided with only one locking member 31 and only one second connecting post 310 is arranged on this locking member 31, the cover plate 12 may be provided with one second elongated hole 120 correspondingly.

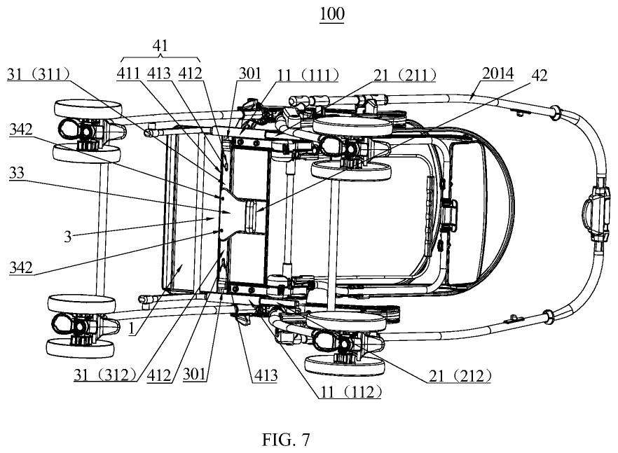

FIGS. 7 to 11 show a configuration of a child carrier 100 according to a second embodiment of the present disclosure. The main difference between this second embodiment and the above first embodiment lies in the structure that realizes movements of the two locking members 31 between the locked position and the unlocked position, and parts same as or similar to those of the above first embodiment will not be described in detail herein.

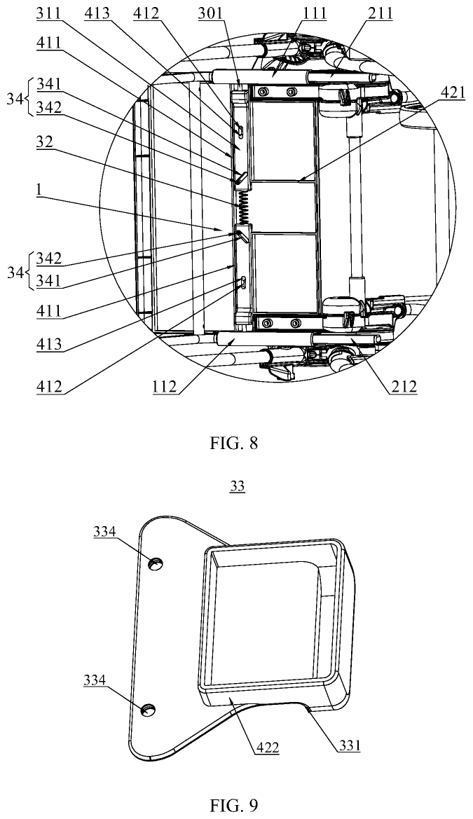

Referring to FIGS. 7 and 8, in the second embodiment, the locking device 3 further includes a first releasing member 33. The first releasing member 33 replaces the cover plate 12 in the above first embodiment and covers the sliding groove 411. The first releasing member 33 can slide in the frontward and rearward directions. The second connecting post 310 in the above first embodiment does not need to be arranged on each of the locking members 31. A first conversion mechanism 34 may be arranged between each of the locking members 31, and the first releasing member 33. The first conversion mechanism 34 is used to convert the frontward and rearward movements of the first releasing member 33 into the leftward and rightward movements of each of the lock members 31, so that the locking pin portion 301 of each of the locking members 31 is inserted into the corresponding positioning hole 210 of the supporting tube 21 or withdrawn from the positioning hole 210, so that each of the locking members 31 reaches the locked position or the unlocked position.

Referring to FIGS. 8, 10 and 11, an exemplary configuration of the first conversion mechanism 34 is illustrated in the second embodiment. The first conversion mechanism 34 may include pairs of an obliquely elongated hole 341 and a fixed post 342. The obliquely elongated hole 341 is arranged on the corresponding locking member 31. The obliquely elongated hole 341 is inclined relative to the left-right direction or relative to the front-rear direction. The fixed post 342 is arranged on the first releasing member 33 and is slidingly fitted with the obliquely elongated hole 341. The fixed post 342 can be formed by, for example, a bolt mounted in a fixed hole 334 of the first releasing member 33. Certainly, in some embodiments, the positions of the obliquely elongated hole 341 and the fixed post 342 arranged in pairs can be interchanged. It can be understood that the implementation of the first conversion mechanism 34 is not limited herein.

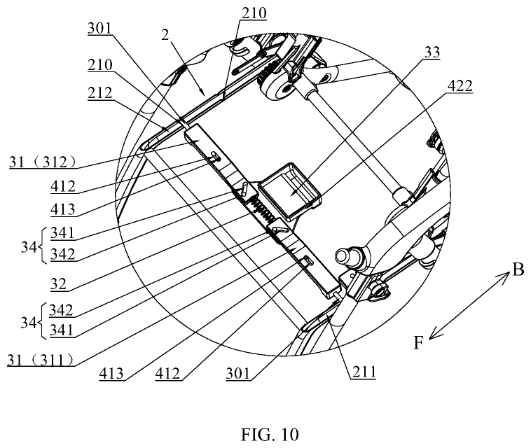

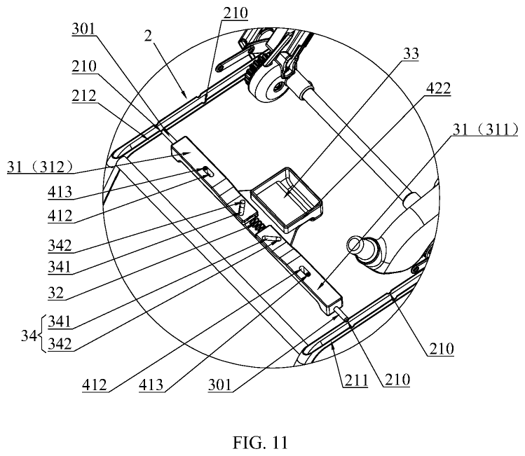

Referring to FIG. 9, the first releasing member 33 may be provided with a handle portion 331 for pulling by a hand. When each of the locking members 31 is in the locked position shown in FIG. 10, if the position of the seat plate 1 needs to be adjusted in the front-rear direction, the external force is applied to pull the handle position 331 backward, and owing to the fit between the obliquely elongated hole 341 and the fixed post 342, the two locking members 31 approach each other in the left-right direction, and the locking pin portion 301 of each of the locking members 31 is withdrawn from the corresponding positioning hole 210 until the locking members 31 reaches the unlocked position shown in FIG. 11. After the sliding sleeve 11 of the seat plate 1 is slid into place along the supporting tube 21 of the seat plate bracket 2, the external force is removed, the elastic element 32 drives the two locking members 31 to move away from each other in the left-right direction, and the locking pin portion 301 of each of the locking members 31 is inserted into the corresponding positioning hole 210 until the locking member reaches the locked position shown in FIG. 10. Owing to the fit between the obliquely elongated hole 341 and the fixed post 342, the first releasing member 33 moves forward and restores original shape.

Referring to FIGS. 7 to 9, in the second embodiment, a second guiding mechanism 42 may be arranged between the first releasing member 33 and the seat plate 1. The second guiding mechanism 42 guides the first releasing member 33 to move in the frontward and rearward directions. The second guiding mechanism 42 can be implemented in many ways, for example, a sliding groove 421 may be arranged on the bottom surface of the seat plate 1, and a slider portion 422 slidingly fitted with the sliding groove 421 may be arranged on the first releasing member 33. In some unillustrated embodiments, an elongated hole extending in the front-rear direction may be arranged on the first releasing member 33, a bolt connected to the seat plate 1 may extend through the elongated hole, and the bolt is slidingly fitted with the elongated hole.

It should be noted that although two locking members 31 are used as an example for illustration in the second embodiment, it can be understood that in other embodiments, only one locking member 31 can also be provided, and the first releasing member 33 is operatively connected to the one locking member 31 through the first conversion mechanism 34.

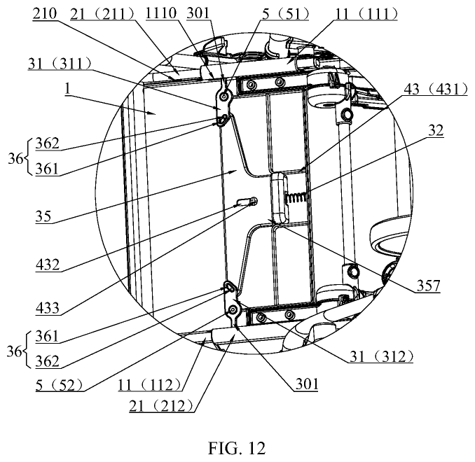

FIGS. 12 to 14 show a configuration of a child carrier 100 according to a third embodiment of the present disclosure. The main difference between the third embodiment and the above second embodiment lies in the configuration of the locking device 3, and parts same as or similar to those of the above second embodiment will not be described in detail herein.

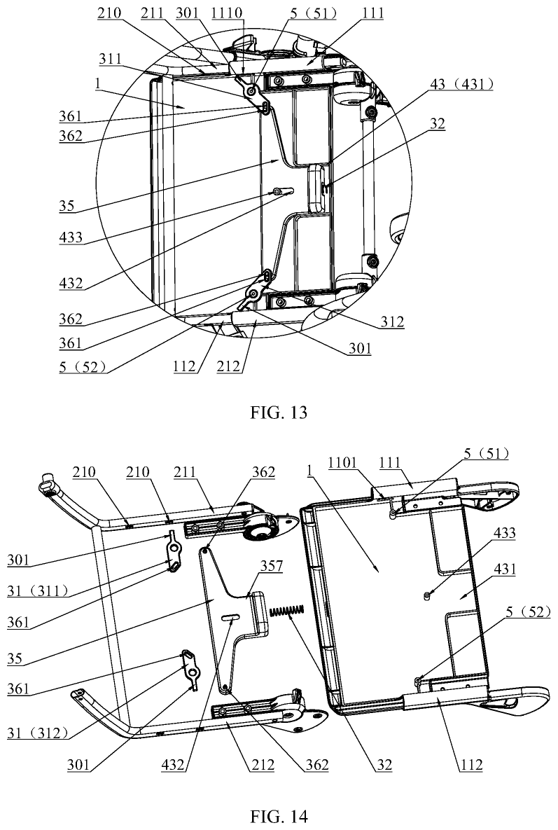

Referring to FIGS. 12 and 13, in the third embodiment, each of the locking members 31 is connected to the seat plate 1 through a corresponding pivot shaft 5. More specifically, as described in the above embodiments, the locking device 3 includes two locking members 31 spaced apart in the left-right direction, the locking member 31 on the left side is referred to as a first component 311, and the locking member 31 on the right side is referred to as a second component 312. Correspondingly, two pivot shafts 5 are provided. For ease of illustration, the pivot shaft 5 on the left side is referred to as a first pivot shaft 51, and the pivot shaft 5 on the right side is referred to as a second pivot shaft 52. The first pivot shaft 51 and the second pivot shaft 52 are arranged between the two supporting tubes 21. The first component 311 is pivotally connected to the first pivot shaft 51, and the second component 312 is pivotally connected to the second pivot shaft 52.

Each of the locking members 31 (the first component 311 or the second component 312) is rotated around the corresponding pivot shaft 5 (the first pivot shaft 51 or the second pivot shaft 52) to be switched between the locked position and the unlocked position, so that the locking pin portion 301 of each of the locking members 31 is inserted into the corresponding positioning hole 210 of the supporting tube 21 or withdrawn from the positioning hole 210. The configuration of each of the positioning holes 210 should facilitate the screwing in and out of the locking pin portion 301 of each of the locking members 31, and when each of the sliding sleeves 11 includes the through hole 1101 for the locking pin portion 301 to pass through, the configuration of the through hole 1101 should also facilitate the screwing in and out of the locking pin portion 301 of the corresponding locking member 31.

In the third embodiment, the locking device 3 further includes a second releasing member 35. The second releasing member 35 is movable in the frontward and rearward directions. A second conversion mechanism 36 is arranged between the second releasing member 35 and each of the locking members 31. The second conversion mechanism 36 is used to convert the frontward and rearward movements of the second releasing member 35 into the rotation of the corresponding locking member 31, so that the locking member 31 reaches the locked position or the unlocked position. The elastic element 32 abuts against the second releasing member 35. Different from the manner in which the elastic element 32 directly acts on the locking member 31 in the first and second embodiments as described above, in the third embodiment, the elastic element 32 acts indirectly on each of the locking members 31 via the second releasing member 35 to keep each of the locking members 31 in the locked position.

An exemplary configuration of the second conversion mechanism 36 is shown in FIGS. 12 and 13. The second conversion mechanism 36 includes pairs of a third elongated hole 361 and a third connecting post 362. For the third elongated hole 361 and the third connecting post 362 arranged in pairs, the third elongated hole 361 is arranged on the corresponding locking member 31, and the third connecting post 362 is arranged on the second releasing member 35. The third connecting posts 362 are slidingly fitted with the third elongated holes 361 respectively. The third connecting post 362 may be formed by, for example, a bolt mounted on the second releasing member 35. Certainly, in some embodiments, the positions of the third elongated hole 361 and the third connecting post 362 arranged in pairs can be interchanged. It can be understood that the implementation of the second conversion mechanism 36 is not limited herein.

When each of the locking members 31 is in the locked position shown in FIG. 12, if the position of the seat plate 1 in the front-rear direction needs to be adjusted, the external force is applied to pull the second releasing member 35 backward, and owing to the fit between the third elongated hole 361 and the third connecting post 362, the two locking members 31 are respectively rotated around the corresponding pivot shafts 5 respectively, so that the locking pin portion 301 of each of the two locking members 31 is withdraw from the corresponding positioning hole 210 until each of the two locking members 31 reaches the unlocked position shown in FIG. 13. After the sliding sleeves 11 of the seat plate 1 are slid in place along the supporting tubes 21 of the seat plate bracket 2 respectively, the external force is removed, the elastic element 32 drives the second releasing member 35 to move forward, and restores original shape, and owing to the fit between the third elongated hole 361 and the third connecting post 362, each of the locking members 31 is rotated around the corresponding pivot shaft 5 so that the locking pin portion 301 of each of the locking members 31 is inserted into the corresponding positioning hole 210 until each of the locking members 31 reaches the locked position shown in FIG. 12.

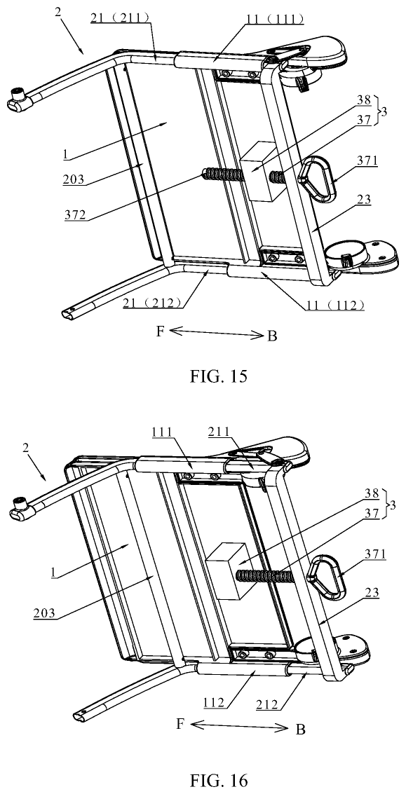

Referring to FIGS. 12 to 13, in the second embodiment, a third guiding mechanism 43 may be arranged between the second releasing member 35 and the seat plate 1. The third guiding mechanism 43 guides the second releasing member 35 to move in the frontward and rearward directions. The third guiding mechanism 43 may be implemented in many ways, for example, a sliding groove 431 may be arranged on the bottom surface of the seat plate 1, and a slider portion 357 (as shown in FIG. 14) slidingly fitted with the sliding groove 431 may be arranged on the second releasing member 35. The elastic element 32 may be disposed in the sliding groove 431 and abut against the second releasing member 35. In some unillustrated embodiments, an elongated hole 432 extending in the front-rear direction may be arranged on the second releasing member 35, a bolt 433 connected to the seat plate 1 may extend through the elongated hole 432, and the bolt 433 is slidingly fitted with the elongated hole 432.

It should be noted that, in other embodiments, the elastic element 32 may include torsion springs sleeved on each of the pivot shafts 5. Two spring arms of each of the torsion springs are respectively connected to the seat plate 1 and the corresponding locking member 31. Each of the torsion springs is used to hold the corresponding locking member 31 in the locked position.

It should be noted that although two locking members 31 are used as an example for illustration in the third embodiment, it can be understood that in other embodiments, only one locking member 31 may be provided, and the second releasing member 35 is operatively connected to the one locking member 31 through the second conversion mechanism 36.

FIGS. 15 to 17 show a configuration of a child carrier 100 according to a fourth embodiment of the present disclosure. The main difference between the fourth embodiment and the above embodiments lies in the configuration of the locking device 3, and parts same as or similar to those of the above second embodiment will not be described in detail herein.

Referring to FIG. 15, in the fourth embodiment, the locking device 3 is, for example, a nut screw mechanism, which includes a nut 38 and a lead screw 37. The nut 38 is fixed on the bottom surface of the seat plate 1. The lead screw 37 is mounted on a mounting frame 23 of the seat plate bracket 2. The lead screw 37 extends in the front-rear direction, and axial movement of the lead screw 37 is restricted. A first end 371 of the lead screw 37 is an operating end, and a second end 372 of the lead screw 37 passes through the nut 38. Therefore, when the first end 371 of the lead screw 37 is screwed, guided by each of the supporting tubes 21 and each of the sliding sleeves 11, the rotation of the lead screw 37 can be converted into an axial movement of the nut 38. Then, the nut 38 can drive the seat plate 1 to move in the frontward and rearward directions. The seat plate 1 in FIG. 15 is closer to the rear end of the seat plate bracket 2 than the seat plate 1 in FIG. 16.

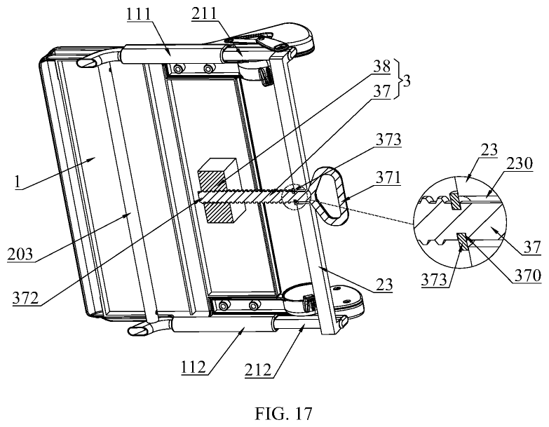

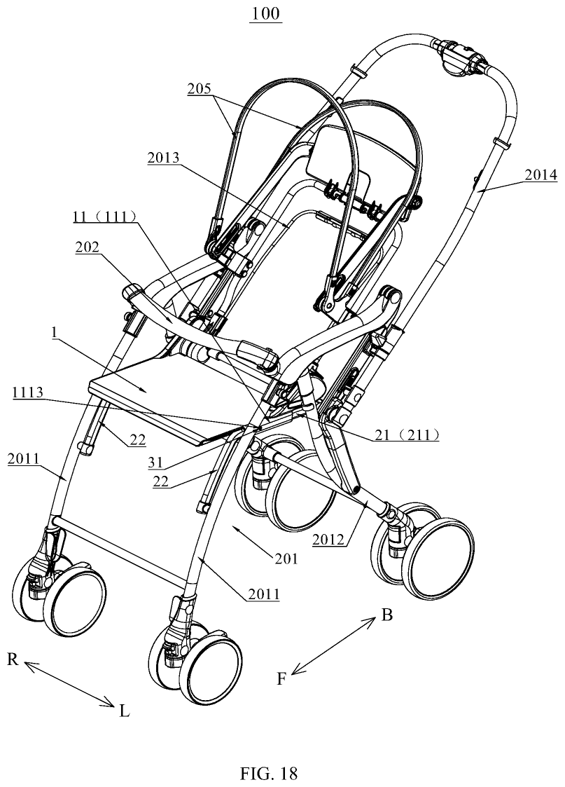

Referring to FIG. 17, the mounting frame 23 is, for example, a horizontal supporting rod connected between the two supporting tubes 21. The horizontal supporting rod cooperates with the connecting cross rods 203 to connect the two supporting tubes 21 together in the front-rear direction. In addition, FIG. 17 shows an exemplary structure for restricting the axial movement of the lead screw 37. Specifically, the mounting frame 23 is provided with a unthreaded hole 230 through which the second end 372 of the lead screw 37 passes. The first end 371 of the lead screw 37 is provided with a handle. The handle may abut against the mounting frame 23 at a first end of the unthreaded hole 230, to restrict the axial movement of the lead screw 37 toward a direction approaching the nut 38. The lead screw 37 is provided with an annular positioning groove 370. A spring retaining ring 373 may be mounted in the annular positioning groove 370. The spring retaining ring 373 abuts against the mounting frame 23 at a second end of the unthreaded hole 230, so as to restrict the axial movement of the lead screw 37 toward a direction away from the nut 38. Certainly, the way of restricting the axial movement of the lead screw 37 is not limited herein.

FIG. 18 shows a configuration of a child carrier 100 according to a fifth embodiment of the present disclosure. The main difference between the fifth embodiment and the above embodiments lies in the configuration of the locking device 3. Specifically, a threaded hole 1113 is arranged on a wall of at least one sliding sleeve 11. The threaded hole 1113 extends in the left-right direction. A bolt capable of being screwed into the threaded hole 1113 is used as the locking member 31 of the locking device 3. The bolt includes an outer end and an inner end, for example, and the locking pin portion 301 is positioned at the inner end. By screwing the bolt, the locking pin portion 301 of the bolt is inserted into the corresponding positioning hole 210, and the locking member 31 is switched to the locked state, thereby locking the position of the seat plate 1 on the seat plate bracket 2. By loosening the bolt, the locking pin portion 301 of the bolt is withdrawn from the positioning hole 210, and even the bolt is completely separated from the threaded hole 1113 and the positioning hole 210, such that the locking member 31 is switched to the unlocked position. In this case, the position of the seat plate 1 can be adjusted in the front-rear direction. The outer end of the bolt may be provided with a structure that facilitates screwing. In addition, in some alternative embodiments, the positioning holes 210 may not be arranged on the supporting tubes 21, and the inner end of the bolt is pressed against the corresponding supporting tube 21 by screwing the bolt, the position of the seat plate 1 on the seat plate bracket 2 can also be easily locked. When the position of the seat plate 1 needs to be adjusted in the front-read direction, the bolts can be loosened. In some embodiments, the outer end of the bolt may be provided with a structure that facilitates screwing.

In the child carrier provided by the embodiments of the present disclosure, the position of the seat plate on the seat plate bracket can be adjusted in the front-rear direction, thereby adjusting the front-rear position relationship between the seat plate and the front armrest, so that the front-rear position relationship between the seat plate and the front armrest can be adapted to the riding needs of children of different sizes.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variants and improvements without departing from the concept of the present disclosure, and the variations and improvements falls in the protection scope of the present disclosure. Therefore, the protection scope of the present disclosure shall be subject to the appended claims.

What is claimed is:

1. A child carrier comprising:
a seat plate;
a seat plate bracket supporting the seat plate; and
a locking device configured to locking a position of the seat plate on the seat plate bracket,
wherein the seat plate is slidable in frontward and rearward directions relative to the seat plate bracket.

2. The child carrier according to claim 1, wherein the seat plate bracket comprises at least two positioning holes arranged at intervals in a front-rear direction;
wherein the locking device comprises a locking member comprising a locking pin portion, the locking member having a locked position and an unlocked position; and
wherein when the locking member is in the locked position, the locking pin portion is inserted into corresponding one of the at least two positioning holes to lock a position of the seat plate on the seat plate bracket, and when the locking member in the unlocked position, the locking pin portion is withdrawn from the corresponding one of the at least two positioning holes to allow the seat plate to slide along the seat plate bracket.

3. The child carrier according to claim 2, wherein the locking device further comprises an elastic element configured to keep the locking member in the locked position; and
wherein the locking member is capable of switching from the locked position to the unlocked position by overcoming elastic force of the elastic element when subjected to an external force.

4. The child carrier according to claim 3, wherein a first guiding mechanism is arranged between the locking member and the seat plate, and the first guiding mechanism is configured to guide the locking member to move leftward or rightward, such that the locking member is switched between the locked position and the unlocked position.

5. The child carrier according to claim 4, wherein the first guiding mechanism comprises a sliding groove or a sliding rail extending in a left-right direction, the locking member being slidingly fitted with the sliding groove or the sliding rail; and/or
wherein the first guiding mechanism comprises a first elongated hole extending in the left-right direction, and a first connecting post slidingly fitted with the first elongated hole, the first elongated hole being arranged on one of the seat plate and the locking member, the first connecting post being arranged on the other of the seat plate and the locking member.

6. The child carrier according to claim 5, wherein a cover plate is mounted on a back of the seat plate, the cover plate covers at least a part of the sliding groove, and the cover plate is provided with a second elongated hole extending in the left-right direction;
wherein the locking member is provided with a second connecting post, and the second connecting post extends through and out of the second elongated hole to receive the external force; and
wherein the elastic element is mounted in the sliding groove.

7. The child carrier according to claim 2, wherein the locking device further comprises a first releasing member movable in the frontward and rearward directions; and
wherein a first conversion mechanism is arranged between the first releasing member and the locking member, and the first conversion mechanism is configured to convert frontward and rearward movements of the first releasing member into leftward and rightward movements of the lock member.

8. The child carrier according to claim 7, wherein the first conversion mechanism comprises an obliquely elongated hole and a fixed post slidingly fitted with the obliquely elongated hole, and
wherein one of the obliquely elongated hole and the fixed post is arranged on the locking member, and the other of the obliquely elongated hole and the fixed post is arranged on the first releasing member.

9. The child carrier according to claim 7, wherein a second guiding mechanism is arranged between the first releasing member and the seat plate, and the second guiding mechanism is configured to guide the first releasing member to move in the frontward and rearward directions.

10. The child carrier according to claim 4, wherein the seat plate bracket comprises two supporting tubes spaced apart in a left-right direction, and the at least two positioning holes are arranged on each of the two supporting tubes;
wherein the seat plate comprises two sliding sleeves sleeved on the two supporting tubes respectively;
wherein two locking members are provided, and the two locking members are positioned between the two supporting tubes and face each other in a straight line; and
wherein the elastic element is clamped between ends of the two locking members which are close to each other, and each of ends of the two locking members away from each other is provided with the locking pin portion.

11. The child carrier according to claim 3, wherein the locking members is connected to the seat plate through a pivot shaft, and the locking member is rotated around the pivot shaft to be switched between the locked position and the unlocked position.

12. The child carrier according to claim 11, wherein the locking device further comprises a second releasing member movable in the frontward and rearward directions; and
wherein a second conversion mechanism is arranged between the second releasing member and the locking member, and the second conversion mechanism is configured to convert frontward and rearward movements of the second releasing member into a rotation of the locking member.

13. The child carrier according to claim 12, wherein the second conversion mechanism comprises a third elongated hole and a third connecting post slidingly fitted with the third elongated hole; and
wherein one of the third elongated hole and the third connecting post is arranged on the locking member, and the other of the third elongated hole and the third connecting post is arranged on the second releasing member.

14. The child carrier according to claim 12, wherein a third guiding mechanism is arranged between the seat plate and the second releasing member, and the third guiding mechanism is configured to guide the second releasing member to move in the frontward and rearward directions.

15. The child carrier according to claim 12, wherein the elastic element abuts against the second releasing member, and the elastic element acts on the locking member via the second releasing member; or
wherein the elastic element is a torsion spring sleeved on the pivot shaft, and two spring arms of the torsion spring are respectively connected to the locking member and the seat plate.

16. The child carrier according to claim 12, wherein the seat plate bracket comprises two supporting tubes spaced apart in a left-right direction, and the at least two positioning holes are arranged on each of the two supporting tubes;
wherein the seat plate comprises two sliding sleeves sleeved on the two supporting tubes respectively;
wherein two pivot shafts are provided, and the two pivot shafts are spaced apart in the left-right direction; and
wherein two locking members are provided, and the two locking members are positioned between the two supporting tubes and sleeved on the two pivot shafts, ends of the two locking members which are close to each other are connected to the second releasing member; and each of ends of the two locking members away from each other is provided with the locking pin portion.

17. The child carrier according to claim 1, wherein the seat plate bracket comprises a mounting frame;
wherein the locking device comprises a nut fixed on a bottom surface of the seat plate, and a lead screw mounted on the mounting frame and extending in a front-rear direction; and
wherein axial movement of the lead screw is restricted, a first end of the lead screw is an operating end, and a second end of the lead screw extends through the nut.

18. The child carrier according to claim 1, wherein the seat plate bracket comprises a supporting tube extending in a front-rear direction;
wherein the seat plate comprises a sliding sleeve sleeved on the supporting tube, and a wall of the sliding sleeve is provided with a threaded hole; and
wherein the locking device comprises a bolt capable of being screwed into the threaded hole, and by screwing the bolt, the bolt is engaged with the supporting tube, to lock a position of the sliding sleeve on the supporting tube.

19. The child carrier according to claim 1, wherein the child carrier is a stroller or a child dining chair, and a main frame of the child carrier comprises a front armrest and the seat plate bracket.
